(19) United States
(12) Patent Application Publication
(10) Pub. No.: US 2007/0286462 A1
(43) Pub. Date: Dec. 13, 2007

(54) System and method for biometric retinal identification

(76) Inventors: David Usher, Waltham, MA (US); Nicholas A. Accomando, Hingham, MA (US); David Muller, Boston, MA (US); Yasunari Tosa, Arlington, MA (US)

Correspondence Address: NIXON PEABODY, LLP, 401 9TH STREET, NW, SUITE 900, WASHINGTON, DC, 20004-2128, US

(21) Appl. No.: 11/785,924

(22) Filed: Apr. 20, 2007

Related U.S. Application Data
(60) Provisional application No. 60/795,645, filed on Apr. 28, 2006.

(51) Int. Cl. G06K 9/00

(52) U.S. Cl. 382/115

(57) ABSTRACT

Retinal blood vessels are detected for biometric identification by: receiving at least one image with retinal data; detecting an area in the image corresponding to a spatial variation in the image; and determining a blood vessel pattern relative in the area. The spatial variation may be determined according to a spatial intensity gradient. The area corresponding to the spatial variation may be defined by a fitted shape. A specific embodiment determines a structural measurement, such as a structural center of mass, in the area, and the blood vessel pattern is determined relative to the structural measurement. The blood vessel pattern may be determined by identifying blood vessel cross sections within the area and linking the blood vessel cross sections to determine blood vessels. Furthermore, each of the blood vessel cross sections may be represented by an N-vector determined by a N-parameter non-linear fitting function or a linear function combination.

### CROSS REFERENCE TO RELATED APPLICATIONS

This application claims priority to U.S. Provisional Application No. 60/795,645 filed Apr. 28, 2006, the contents of which are incorporated entirely herein by reference.

### BACKGROUND OF INVENTION

1. Field of Invention

The present invention relates to biometric analysis of a retinal image, and more particularly, to biometric analysis of a blood vessel pattern in an area of the retinal image with high structural content.

2. Description of the Related Art

Due to the unique character of each individual's retina, various systems attempt to use the retina for biometric identification. Previous approaches have focused on identifying the boundaries of the optic disc in a retinal image and using features of the optic disk as a basis of comparison with other retinal images.

In particular methodologies, the optic disk boundary is used as a fiduciary and blood vessels are segmented, encoded, and matched with respect to this specific fiduciary. There are generally five aspects to a system implementing a retinal algorithm in these methodologies: optic disk image auto-capture; blood vessel segmentation; encoding; matching; and data retrieval and caching strategy. Optic disk image auto-capture involves consistent detection of the optic disk boundary in multiple captured frames. Optic disk image auto-capture is combined with blood vessel segmentation. Specifically, blood vessel segmentation involves locating blood vessel cross-sections using a model-fit method applied along concentric ellipses based on the detected optic disk boundary. Encoding entails recording three parameters for vectors representing the width of the blood vessel cross-sections, as well as their positions with respect to the optic disk. Meanwhile, in matching, the vectors recorded during encoding are compared to a database of stored vectors from reference images, and a matching score is produced reflecting the percentage of matching vectors in the comparison. Data retrieval and caching strategy employs flat files stored in disk directories, where video frame, encoded data, and header information for stored images are retrieved as one monolithic file.

### SUMMARY OF THE INVENTION

Unlike the methodologies described above which depend on the information available in the proximity of the detected optic disk boundary, embodiments of the present invention detect and use data from any area of the retinal image that contains high structural content. The embodiments enable image auto-capture, blood vessel segmentation, encoding, matching, and data retrieval and caching according to areas of spatial variation in the image, i.e. spatial intensity variations of pixel intensity values, rather than a fiduciary such as the optic disk.

In particular, an embodiment of the present invention identifies retinal blood vessels for biometric identification by: receiving at least one image with retinal data; detecting an area in the image corresponding to a spatial variation in the image; and determining a blood vessel pattern in the area. The image may be an image bitmap. The spatial variation may be determined according to a spatial intensity gradient. Furthermore, the area corresponding to the spatial variation can be defined by a fitted shape.

A specific embodiment determines a structural measurement in the area corresponding to the spatial variation. For instance, the structural measurement can be a structural center of mass. In such an embodiment, the blood vessel pattern is determined relative to the structural measurement.

A further embodiment determines the blood vessel pattern by determining blood vessel cross sections within the area corresponding to the spatial variation and linking the blood vessel cross sections to determine blood vessels. The blood vessel pattern can include blood vessel bifurcations and locations of entry and exit from the retina. Each of the blood vessel cross sections can be represented by an N-vector determined by a N-parameter non-linear fitting function or a linear function combination. For instance, a non-linear five-parameter model can be fit to intensity profiles within the boundary according to a Levenberg-Marquardt method.

Once the blood vessel pattern is determined, it can be saved for future biometric identification. Alternatively, it can be compared with a reference blood vessel pattern for immediate identification. Regions of interest around the detected blood vessels can be used to normalize or align the blood vessel patterns before they are compared for identification.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE FIGURES

FIG. 1 illustrates the auto-capture process in an exemplary embodiment of the present invention.

FIG. 2 illustrates the image quality test employed by the auto-capture process in an exemplary embodiment of the present invention.

FIG. 3a illustrates the auto-capture process in another exemplary embodiment of the present invention.

FIG. 3b illustrates the auto-capture process in yet another exemplary embodiment of the present invention.

FIG. 4 illustrates the detection of the vessel cross-sections and blood vessels in an exemplary embodiment of the present invention.

FIG. 5 illustrates a chart with an example comparison of raw data to a calculated model using the Levenberg-Marquardt algorithm.

FIG. 6a illustrates a retinal video frame showing blood vessel structure.

FIG. 6b illustrates an exemplary application of a polar-coordinate method in the segmentation of the blood vessel structure.

FIG. 6c illustrates an exemplary application of a Cartesian coordinate method in the segmentation of the blood vessel structure.

FIG. 7 illustrates an exemplary embodiment of the retinal matching process.

### DETAILED DESCRIPTION

In order to provide a system and method for biometric retinal identification, exemplary embodiments of the present invention employ areas of a retinal image that contain high structural content. Structural content is a measure of the spatial variation in an image, i.e. spatial intensity variations of pixel intensity values. The area of highest structural content does not have to be bounded by a simple geometric shape, and its center usually occurs near the densest area of large vessel concentration and bifurcation. While exemplary embodiments may employ geometric shapes for calculation purposes, they do not merely fit a geometric shape to a generalized retinal image. In particular, the calculations performed within the boundary are dependent on data conditions in small areas within the boundary. For instance, the calculations may be performed in a locally adaptive manner based on the ratio of very bright pixels to total pixels in a small neighborhood.

In order to identify areas of greatest structural content and derive biometric data from these areas, embodiments of the present invention may use the following fiduciary set within the retinal image:
The structural center of mass (SCM) of the region of the intensity gradient of the image with significant mass.
The geometric center of all vessels (center of vessels) located around the SCM in the Cartesian coordinate space of the original image, irrespective of whether the vessels are detected in concentric polar-unwrapped annuli centered on the SCM or directly in the Cartesian coordinate space.
Bifurcations and entry/exit points of the largest blood vessels and/or the complete paths of the blood vessels.
Pixel intensities within regions of interest (ROIs) around each vessel and the employment of hierarchical multi-resolution template matching for registration, in either Cartesian or polar-unwrapped coordinates utilizing the ROIs or the vessels, or a simultaneous/sequential combination thereof.

These candidate fiduciary points are semi-invariant, clear and ubiquitous. Thus, this fiduciary set can be reliably found under the expected imaging conditions.

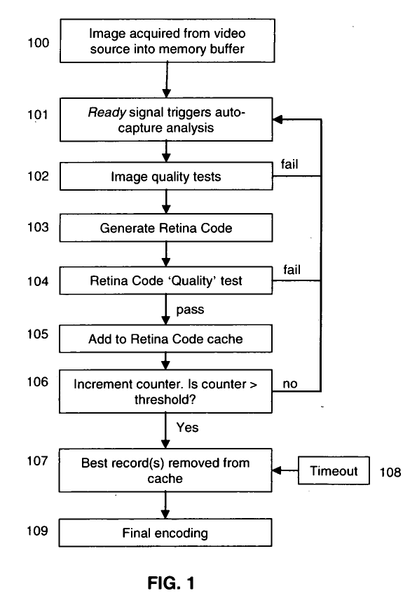

The process of capturing a retinal image is described with reference to FIGS. 1, 2, 3a, and 3b. An ocular device employable with embodiments of the present invention as a retinal image capture device is disclosed in U.S. Provisional Application No. 60/819,630, filed on Jul. 11, 2006, the contents of which are incorporated entirely herein by reference.

Steps 101 through 106 of FIG. 1 illustrate an exemplary embodiment of the auto-capture process. Initially, in step 100, a plurality of video frames of a retinal image are captured with a retinal camera, such as the retinal image capture device referenced previously, and are sequentially read into memory in the form of image bitmaps. The auto-capture process extracts the required biometric information from a video sequence of frames. In step 101, the auto-capture analysis for a video frame begins when a “ready” signal indicates that the bitmap transfer from the camera is complete. For each frame in the video sequence, an assessment of the quality of the image is performed, in step 102.

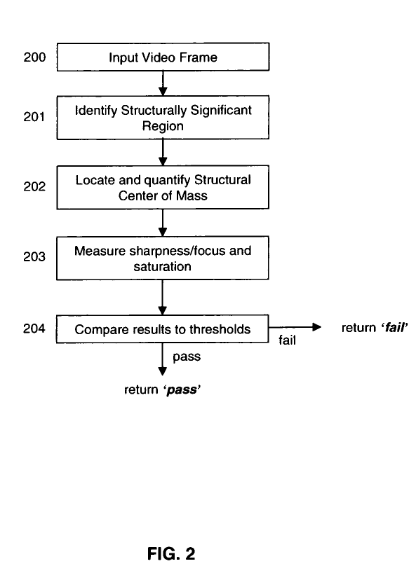

The details of the assessment, or image quality test, are further illustrated in FIG. 2. In one application of an exemplary embodiment, the field-of-view of the camera system (CFOV) is circular. The boundary of the CFOV within the video frame is determined by utilizing horizontal, vertical, and angular projections of intensity and/or gradient of the video frame, followed by local edge detection, either singular or multi-resolution hierarchical. The boundary of the CFOV is then non-uniformly shrunk until significant intensity and/or gradient mass is detected to be a region known as the structurally significant region (SSR), indicated as step 201. The SSR is then fit to a geometric shape. The geometric shape is then used to define a particular coordinate system, e.g. a rectangle can be used to define a Cartesian coordinate system or an ellipse can be used to define a polar coordinate system, but embodiments of the present invention are not limited to the use of a particular shape or coordinate system. In step 202, the structural center of mass (SCM) is located as the center of mass of the intensity gradient with significant mass within the SSR. Although the center of mass of the intensity gradient is used in this exemplary application of the present invention, any measure of structure can be implemented.

In step 203, sharpness and focus, as well as saturation, are measured. As the image sequences peak in focus, vessel detail becomes clearer or sharper. Increasing detail is measured as an increase in gradient strength near structural edges. An overall increase in the intensity gradients within an image indicate an increase in focus. Alternatively, a high pass filter can be used to quantify high frequency components within an image. These high frequency components increase with focus.

Additionally, as a user aligns with a retinal image capture device, the overall signal increases as the user becomes more optimally aligned in accordance with the operation of the device. Therefore, in addition to assessing focus, overall signal intensity can be used to assess when a user is optimally aligned. This can be manifested as an overall increase in pixel intensities (and contrast) within an image.

However, as intensity increases, areas of the image may become saturated. In other words, groups of pixels, or picture elements, achieve their maximum attainable intensity values, creating “white areas” where detail becomes washed out. If enough -detail is washed out, the vessels cannot be reliably located. Accordingly, saturation is identified and measured by searching for clusters of very high intensity pixels in regions containing structure and recording the number of pixels with values above a predetermined or adaptive threshold.

Finally, in step 204, the results of any of the steps 201 through 203, or any combination or weighted combination thereof, are compared to predetermined or adaptive thresholds. If the thresholds are not met or exceeded, the captured image fails the image quality test and the video frame is discarded and the process returns to step 101 in FIG. 1, where analysis of a new video frame is triggered.

If, however, the video frame passes the image quality tests, a retina code is generated for the image as shown in step 103 in FIG. 1. In particular, all vessel cross sections (VCSs) are identified within the SSR, determined in step 201 above. The VCSs are then merged and linked together into a sequence of individual vessels. Generating the retina code in step 103 incorporates the steps of segmentation and encoding described in detail below. In step 104, the retina code is then subjected to a retina code quality test, where results of step 103 are checked for a minimum number of vessels, minimum combined total blood vessel path length, minimum intensity contrast levels for the vessels and/or VCSs, minimum number of bifurcations and/or entry/exit points, or combinations thereof. Checking a minimum number of VCSs is a way of checking a minimum combined total blood vessel path length. These metrics determine the qualities of a “good” retina code. It is understood, however, that other aspects of the retina code can be used as a part of the retina code quality test. If the retina code of step 103 fails to meet the requirements set in step 104, the image from the particular video frame is discarded and the process returns to step 101 in FIG. 1, where analysis of a new video frame is triggered.

If the image passes the retina code quality test of step 104, the retina result, including the video frame and the data from image analysis, is placed in a cache in step 105. The cache holds a ranked queue-of retina results from the plurality of video images in memory. The retina results are ranked according to criteria, which may include, but are not limited to, the maximum number of vessels, maximum number of VCSs, intensity contrast of the vessels and/or VCSs, focus measure, or combinations thereof. A maximum of M (M≧1) retina results are held in the cache for comparison with available data for biometric identification/verification, or K (K≧M) retina results for enrollment of new biometric data. If, at step 105, the cache already contains the maximum permitted number of retina results, M or K, the current retina result replaces the lowest ranking retina result in the cache if it ranks higher. In step 106, a counter keeping track of how many video frames have reached this point is incremented. If this counter exceeds a threshold T, (T≧M for identification/verification or T≧K for enrollment), the auto-capture is halted and the process continues with step 107, where the best N results (1≦N≦M or 1≦N≦K), are extracted from the cache and passed to step 109. Otherwise, if the counter has not reached the threshold, the process returns to step 101 to process more images. At any point during the auto-capture process, a timeout signal can be sent by the controlling software and the auto-capture process is halted and the process continues to the final encoding step 107. If, however, at this point, fewer than N results are contained in the cache, the auto-capture has failed to extract the required information and a “fail to acquire” signal is returned. Otherwise, the N retina results are then passed to the next processing step detailed below.

At step 109, a blood vessel segmentation and encoding process generates a final retina encoding. This final encoding can take the exact same form as the retina code as generated in step 103. In this case no further processing takes place at step 109. In the preferred embodiment the final segmentation and encoding step is similar to that of step 103 except that it constitutes a more thorough process. Namely the blood vessel segmentation method, as described below, is applied more exhaustively within the SSR. Other embodiments may apply alternative segmentation and encoding methods not related to the segmentation- and encoding steps applied in step 103. If the retina results are being used for biometric identification or verification, the results proceed to alignment and matching modules. If the retina results are being used for biometric enrollment, the results can be compressed and/or encrypted for future use or may be passed on to alignment and matching modules to test for repeat enrollments.

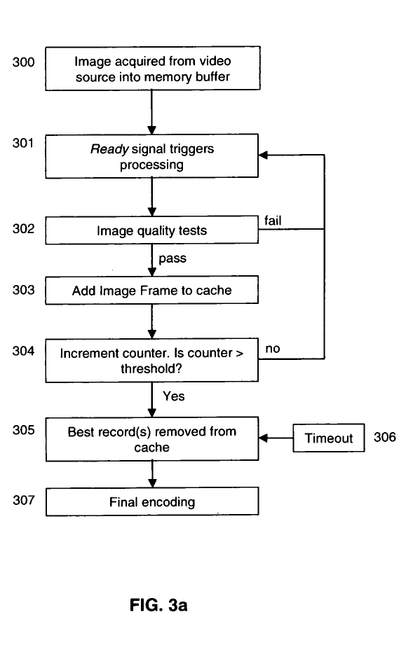

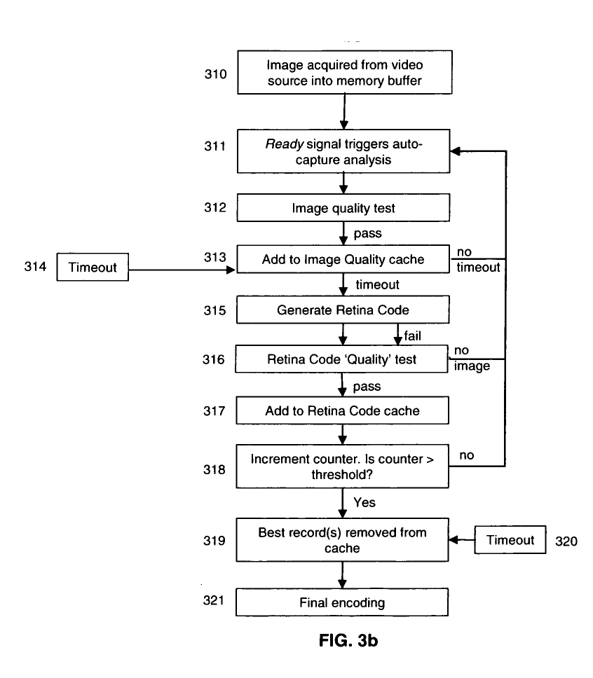

An alternative embodiment of the auto-capture process is shown in FIG. 3a, where steps 301 through 304 make up an auto-capture process. Initially, in step 300, a plurality of video frames of a retinal image are captured with a retinal camera and are sequentially read into memory in the form of image bitmaps. The auto-capture process extracts the required biometric information from a video sequence of frames. In step 301, the auto-capture analysis for a video frame begins when a “ready” signal indicates that the bitmap transfer from the camera is complete. For each frame in the video sequence, an assessment of the quality of the image is performed, in step 302. The details of the image quality test are illustrated in FIG. 2, as discussed previously. However, contrary to the embodiment shown in FIG. 1, segmentation and encoding does not take place in the auto-capture process and occurs after the caching process in step 307. If the image passes the image quality test of step 302, the retina result, including the video frame and the data from image analysis, is placed in a cache in step 303. Thus, contrary to the embodiment shown in FIG. 1, a retina code quality test is not employed, and instead, the images are placed into the cache and ranked according to the image quality test results. The process illustrated in FIG. 3a employs a counter and a timeout similar to that of FIG. 1 described previously. In step 305, the highest ranking images are passed on to the final encoding step 306. One possible variation of the embodiment shown in FIG. 3a includes a retina code quality test at the final encoding step 306 and returns a “fail to acquire” signal if the images fail the test.

FIG. 3b illustrates yet another embodiment of the auto-capture process, which is similar to the embodiment shown in FIG. 1. Initially, in step 310, a-plurality of video frames of a retinal image-are-captured with a retinal camera and are sequentially read into memory in the form of image bitmaps. The auto-capture process extracts the required biometric information from a video sequence of frames. In step 311, the auto-capture analysis for a video frame begins when a “ready” signal indicates that the bitmap transfer from the camera is complete. For each frame in the video sequence, an assessment of the quality of the image is performed, in step 312. The details of the image quality test are illustrated in FIG. 2, as discussed previously. Departing from the embodiment shown in FIG. 1, the next step 313 adds the image to an image quality cache if the image has a minimum image quality test score. Images are added to the cache until a timeout 314 occurs. The timeout 314 can be measured from the point when the first image meets the minimum image quality test score, or from the start of image acquisition. (Alternatively, instead of using a timeout, a counter can be used where the process of step 313 ends after a certain number of images have been analyzed.) The image quality cache holds a queue of images from the image quality test ranked according to score. If, at step 313, the image quality cache already contains the maximum permitted number of images, the current image replaces the lowest ranking image in the cache if it ranks higher. At the timeout 314, step 315 generates a retina code for the highest ranking image in the cache. Step 315 incorporates the steps of segmentation and encoding described in detail below. In step 316, the retina code is then subjected to a retina code quality test, where the results of step 315 are checked for a minimum number of vessels, a minimum combined total blood vessel path length, minimum number of bifurcations and/or entry/exit points, or combinations thereof. Checking a minimum number of VCSs is a way of checking a minimum combined total blood vessel path length. If the retina code of step 315 fails to meet the requirements set in step 316, the image from the particular video frame is discarded and the process returns to step 315, where the retina code of the next highest ranking image in the image quality cache is determined. Once a retina code meets, or passes, the requirements set in step 316, the process continues immediately to step 317, without further processing of the remaining images in the image quality cache. If the images in the image quality cache are exhausted before an image meets the requirements for the retina code quality test, the process returns to step 311 to process more images. At the timeout 314 an alternative embodiment generates retina codes for all or a subset of the images in the image quality cache. The highest ranking retina code meeting the requirements set in step 316 is then passed on to step 317.

If the image passes the retina code quality test of step 316, the retina result, including the video frame and the data from image analysis, is placed in a retina code cache in step 317. The retina code cache holds a ranked queue of retina results from the plurality of video images in memory, similar to the cache of step 105 in the embodiment of FIG. 1. In step 318, a counter keeping track of how many video frames have reached this point is incremented. If this counter exceeds a threshold, the auto-capture is halted and the process continues with step 319, where the best N results are extracted from the cache and passed to step 321. Otherwise, if the counter has not reached the threshold, the process returns to step 311 to process more images. At any point during the auto-capture process, a timeout signal 320 can be sent by the controlling software and the auto-capture process is halted and the process continues to the final encoding step 321. If, however, at this point, fewer than N results are contained in the cache, the auto-capture has failed to extract the required information and a “fail to acquire” signal is returned. Step 321 is equivalent to step 109 in FIG. 1.

In a variation of the embodiment illustrated in FIG. 3b, images are added to the image quality cache in step 313, but timeout 314 does not halt additions to the image quality cache. Instead, in step 313, images are added to the cache until an image has a score from the image quality test that fails to meet a set threshold. Once an image fails to meet the threshold, regardless of how many images have been added to the image quality cache, the process proceeds to step 315 and subsequent steps, as described above. This variation may be particularly useful when attempting to obtain the best frames as an individual is moving through a focusing process-with the device, where failure to meet the threshold marks a distinct event during the process.

As described previously, encoding and segmentation occurs either during the process of auto-capture or immediately following the auto-capture at steps 109, 307 and 321 in FIGS. 1, 3a and 3b respectively. Encoding and segmentation can also occur during the matching process. To generate a retina code, all vessel cross sections (VCSs) are identified within the SSR and linked together into a sequence of individual blood vessels. A VCS is a segment of a blood vessel centered on a particular location relative to the SCM in either polar-unwrapped coordinates or Cartesian coordinates. Alternatively, the location of the blood vessel segments can be measured to the image frame itself, e.g. relative to the top lefthand pixel (0,0). A contiguous sequence of VCSs sharing similar properties constitute an identified blood vessel. Each VCS is an N-vector representing local blood vessel position, width, amplitude, and skew, as well as other vessel parameters as determined from an N-parameter non-linear fitting function and/or various individual linear function combinations.

In a polar-unwrapped or Cartesian SSR, the N-parameter non-linear fitting function and/or various individual linear function combinations are applied to points within the SSR. One embodiment utilizes the Levenberg-Marquardt algorithm to fit a Gaussian model along intensity profiles in the SSR. In the case of a polar-unwrapped method, the SSR is sampled into J intensity profiles of length I along concentric ellipses at J different radii. In the case of a Cartesian method, the SSR is sampled to J intensity profiles of length I along the x-axis and K intensity profiles of length L along the y-axis.

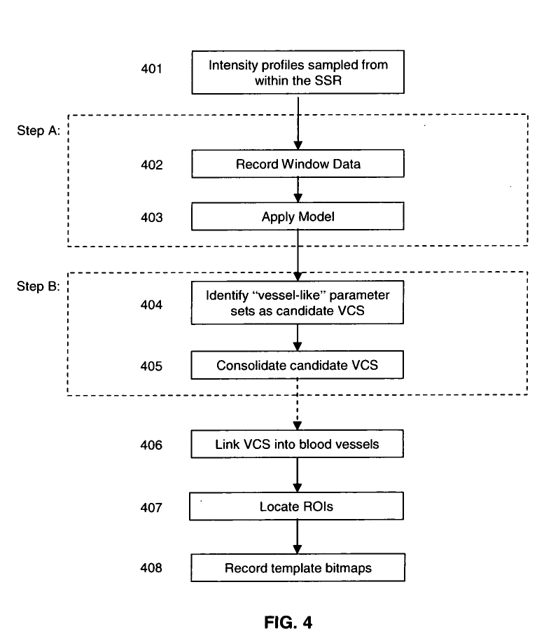

As shown in FIG. 4, the model fitting method consists of two parts. The first part A, shown as steps 401 and 402, fits a five-parameter model to the intensity profile and records the results for every point along the intensity profile. The second part B, shown as steps 403 and 404, records instances of vessel cross sections by analyzing the local model parameters.

Initially, intensity profiles are sampled from within the SSR, shown as step 400. In step 401, for each and every point, .i, along-each intensity profile, a window of values centered on i is recorded. These intensity values become the local data for the application of the model-fitting method in step 402. The Levenberg-Marquardt method can be used to fit a non-linear five-parameter model to the data in the window. The model is constructed from the addition of a one-dimensional Gaussian curve, used to approximate the profile of a blood vessel, and a straight line, used to approximate the local gradient of the intensity within the image. The model function is:
y=p₁*exp[−(x−p₂)²/(p₃)²]+p₄*x+p₅,
where the five parameters are:
p₁=Amplitude of Gaussian
p₂=Position of Gaussian
p₃=Gaussian's variance
p₄=Gradient of straight line
p₅=Intercept of straight line

The parameters are set to initial default values with p₂ set to i, and the Levenberg-Marquardt method is used to fit this function to the data, and the five parameters are recorded for each point, i, in each intensity profile. An example result is shown in FIG. 5, which compares raw data and a calculated model using the Levenberg-Marquardt algorithm.

In step 403, parameter sets from step 402 resembling blood vessels are identified. A function is used to record sets of parameters that could represent VCS (candidate VCSs), where the parameters fall within defined tolerances. In step 404, the candidate VCSs from step 403 are consolidated. If the parameters for a candidate VCS match the parameters for neighboring points, a VCS is recorded, represented by the five parameters. Repeat detection of a single vessel is consolidated into a single record, where a set of five parameters represents a particular combination of those recorded at a particular point and those recorded at neighboring points. All detected VCSs are recorded for all the intensity profiles for each image.

Search algorithms for the steps above include, but are not limited to, exhaustive search, hierarchical search, and directed search. In an exhaustive search, all points detected in the-retinal image are fit. In a hierarchical search, every location (i, j), where i≧1 and j≧1, is fit and is followed by local neighborhood searches around the resulting initial vessel cross sections. The hierarchical search may be performed at multiple resolutions. In a directed search, initial points to be fitted are chosen by local parameters, which include, but are not limited to, gradient and/or intensity strength relative to surroundings and presence of line segments. This first step in the directed search is followed by local neighborhood searches around the resulting initial vessel cross sections. The directed search may also be performed at multiple resolutions.

The initial VCSs may be merged into final VCSs along preferred directions. Merging allows the refinement of the fit parameters while reducing the many vessel representations along the preferred direction to more reliable representations. Merging techniques can include comparison of differences of neighboring VCS parameters to predetermined and/or adaptive thresholds and combining parameters into a new, single VCS if the thresholds indicate enough similarity. One example is the merging of initial VCSs into final VCSs angularly (horizontally) for each radial step (column) on a polar unwrapped grid.

In step 406 of FIG. 4, the final VCSs can then be linked to obtain individual vessels. One method includes vessel growing by linking nearby VCSs in predetermined or adaptively determined local regions via metrics such as those utilized for VCS merging. The linking of VCSs can then be followed by identification of bifurcation and entry/exit locations or vessel continuations at VCSs potentially belonging to multiple vessels. This can be accomplished by the same techniques used for merging.

Once the blood vessels are identified, regions of interest (ROIs) are located about the blood vessels, further illustrated as step 407 in FIG. 4. The ROIs are also referred to as template ROIs as they are subsequently used during the template bitmap normalization and registration steps described below. In one embodiment, these ROIs are set to be 32-by-32 pixels in size and their centers are located by finding the position along each detected blood vessel that contains the most structure. Structure can include image intensity gradients. Variations of this method include using variable sizes of ROIs that bound detected blood vessels. ROIs can also be located about detected vessel bifurcation and/or entry/exit points. An alternative embodiment defines a single, relatively large, ROI centered at the either the center of the SSR or the center coordinate calculated by averaging the coordinates of all the VCSs. It is understood, however, that the ROI may be centered at any arbitrary center calculated for the image. The geometric relationship between the ROIs in the image plane is preserved as the ROIs are recorded with reference to the image coordinates. Four values representing each ROI can be recorded, the indexes of the left and right most columns and indexes of the top and bottom most rows.

In step 408, bitmaps representing image intensity gradients corresponding to each ROI are recorded. These bitmaps are the size of each corresponding ROI and contain pixel values representing local intensity gradients in the original video frame. These bitmaps are the template bitmaps used in the normalization and registration steps below.

Although the template matching approach described herein aligns images according to intensity gradients, an alternative embodiment of the present invention can align the blood vessel segmentations directly.

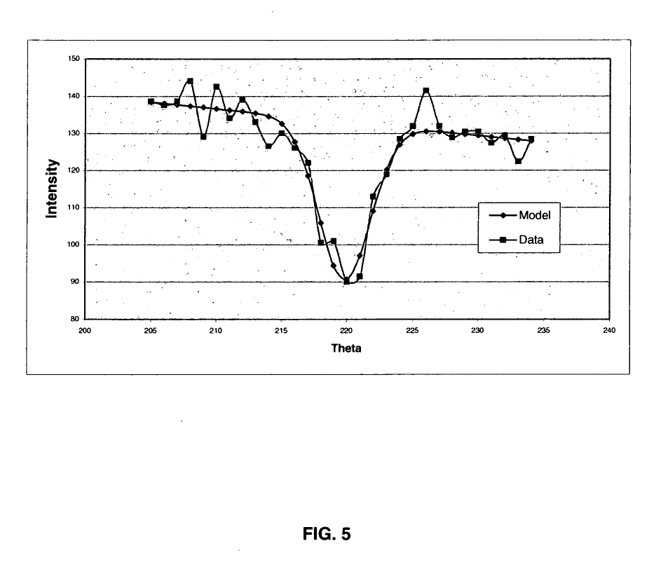

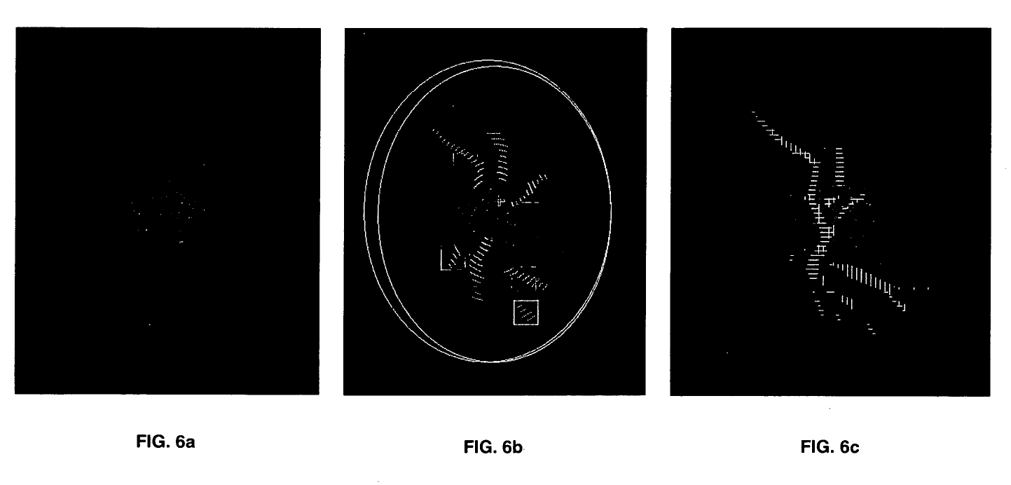

FIGS. 6a-6c illustrate examples of some segmentation results. In particular, FIG. 6a shows an example of a video image frame containing blood vessel structure. FIG. 6b shows the same frame with examples of the polar coordinate based method results overlaid. The outer ellipse defines the structurally significant region (SSR). The structural center of mass (SCM) is shown as the central crosshair at the center of the smaller ellipse. VCS are shown as white arc lines and blood vessel results are defined as local contiguous sequences of VCSs. For each vessel a 32-by-32 maximum structure ROI can be seen. FIG. 6c shows result for a Cartesian based method. In this case, the structurally significant region (SSR) can be seen defined as a rectangle. Once again, VCSs can been-seen as-white lines and detected blood vessel results are defined as local contiguous sequences of VCSs.

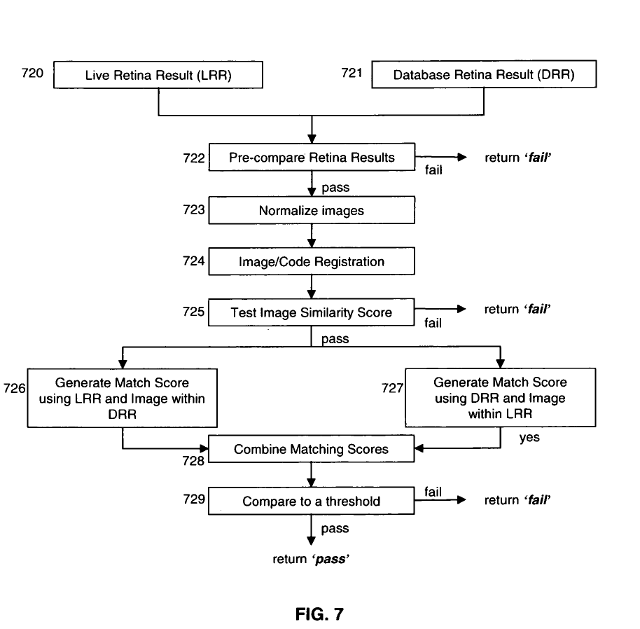

FIG. 7 illustrates the matching process, where a live retina result (LRR) is matched to a previously recorded database retina result (DRR). The live retina result refers to a retina result encoded using a video sequence generated for the current user of the device. The database retina result refers to a retina result encoded and stored (enrolled) at a previous time. The retina result matching algorithm determines whether the two retina results represent the same individual. The matching algorithm produces a “true” or “false” signal, where a “true” result indicates that the retina results are from the same individual.

Initially, the LRR and DRR are loaded into memory. As described above, each encoding result contains an image bitmap corresponding to the recorded video frame. Thus, the matching process operates with a series of bitmaps, each indicating intensity gradients in a recorded video frame and information characterizing the blood vessels contained in the recorded video frame, known as the retina code.

As shown in FIG. 7, a pre-compare step is applied to the retina codes in step 722. A series of tests are applied to the retina codes to identify large discrepancies between the blood vessel patterns of the object (currently acquired) image with the LRR and the reference (enrolled) image with the DRR. If large discrepancies are indeed identified, the pre-compare test returns a “false” result indicating that the retina codes are not from the same person. Otherwise, the method proceeds to step 723.

In one embodiment, the pre-compare step first filters out twenty-five to fifty percent of the reference candidates very swiftly with an intra-retinal code correlation comparison. This comparison is made between vessel pairs in the object and reference images, for which coincidence of the SCMs between the object and reference images is not as important. The information that is used to compare the vessel pairs includes, but is not limited to, the distance between-vessel centers, vessel pair angles, and the difference in vessel pair lengths and widths. These comparisons are performed on a subset of the vessel pairs available and are compared to thresholds.

If the previous comparison does not rule out a match between the object and reference images, the pre-compare step 722 in one embodiment may proceed to direct comparison, or matching, between the images. The search algorithms for this matching include, but are not limited to, exhaustive search, hierarchical search, and directed search. In an exhaustive search, all vessels are matched to all other vessels, cross section by cross section at all increments in a search region. In a hierarchical search, all vessels are matched to all other vessels, cross section by cross section at locations (i,j), where i≧1 and j≧1, followed by local neighborhood searches around the resulting smallest difference points. The hierarchical search and directed search can be performed at multiple resolutions. In this embodiment, this comparison technique in step 722 may serve as the final matching stage. A similarity score between the two encodings is compared to a threshold. A “true” or “false” signal is generated depending on this threshold being exceeded. Therefore, in this particular embodiment, the matching process terminates at step 722.

However, a plurality of images of a retina result may represent the retina of the same individual, but differences between images may result from differing recording conditions. For instance, human alignment with the capture device and pupillary differences can result in variations in the intensities in images from the same individuals, where some images may be generally darker than others. Accordingly, the images may preferably be normalized as shown in step 723. In particular, template bitmap normalization may be employed to correct for average (per data point) gradient intensity differences between the SSR of an object retina code and the SSR of a reference (enrolled) retina code. As described previously, the template bitmaps are derived from the detection of ROIs or a single centered ROI within the image. In one embodiment, a scale factor is applied to each data point in the reference template bitmaps. The scale factor is the ratio of the average (per data point) gradient intensity in the object retina SSR and the average (per data point) gradient intensity in the reference retina SSR. In another embodiment, every object retina area to be matched to a reference retina template bitmap is scaled by the ratio of the average gradient strength in the reference retina template bitmap and the average gradient strength in the object retina area. The normalization enables template matching based on structural rather than intensity differences between the object area and the reference template. Other implementations include removing background low level gradients from the template bitmaps using adaptive global or local thresholds.

In addition to variations in the intensities, alignment variations may also result in displacements in the position of the blood vessel pattern as recorded in the fixed field of view of the camera. Accordingly, the image/ retina code registration, which occurs in step 724, accounts for variations in the positions of the blood vessel patterns between images as introduced by the image capture process. In particular, step 724 determines the displacement between the blood vessel structures as recorded in the two images by aligning the blood vessels between the images.

Due to the two-dimensional projection in the image plane of the three-dimensional retinal surface and the degrees of freedom in the movement of the eye, this displacement can occur as a non-linear deformation. This deformation can be modeled by an elastic transformation defined using tie-points centered on blood vessel features.

Measurement of the displacement, in either the polar unwrapped or Cartesian systems, may begin with an initial value of the difference between the SCMs of the object and reference retinas. The difference is applied to the VCSs of the object retina. If no fiduciary point is used, the coordinates of the VCSs may be centered on an arbitrary coordinate system. Vessel-by-vessel comparisons of distance are performed between the object and reference retinas, refining the center-to-center distance between the retinas. At this stage, a directed search is performed to find the optimal displacement between the two retinas. In one embodiment, a difference between SCMs is calculated. In an alternative-embodiment-a displacement between the blood vessel-patterns is calculated. In one embodiment, the optimal difference minimizes the distances between vessels in the reference and object images. In another embodiment, the optimal difference maximizes the number of points with final matching differences between VCSs in the reference and object images.

Alternatively, the displacement can be modeled using a sequence of rigid-body transformations encompassing translations, rotations, and shears. In step 724 of an alternative embodiment, the deformation is modeled using a single rigid-body translation, (tₓ, t_{y}). Once calculated this translation can be used to align retina codes directly or to register the two images such that the blood vessels structures align. In this particular embodiment, a hierarchical multi-resolution template matching is used to register the two images. The method uses the template bitmaps recorded with the DRR and matches them to an intensity gradient image derived from the video frame contained in the LRR. The matching takes place though a range of translations at various scales with the result set as the highest scoring translation at the largest scale. A search sequence is predefined that details how many different scales are to be used, and in what sequence. Each scale refers to a reduction factor in the size of the live image and the template bitmaps. In addition, at each scale a sequence of step sizes is defined. In one implementation, a match for a given translation can be calculated using a binary AND of overlapping pixels. Other metrics may be used including the absolute differences between pixels or normalized cross-correlations. An initial search space is defined for the starting scale and step size. This search space is defined to include all expected actual translations between images. For all possible translations in the search space, at a step resolution defined by the step size, a score is calculated. The highest scoring translation is remembered and the search space at the next step size is defined by the differences in the last and current step sizes. If the search sequence defines no further step size resolutions at the current scale then the template matching moves onto the next scale in the search sequence. The current best translation and the new search space are both scaled according to difference between the last and current scale factors. This procedure continues until there are no further scales and step size resolutions defined in the search sequence. Another embodiment allows for more than one optimal translation to be kept at a given scale or step size and number of best scores corresponding to different translations are compared at the conclusion of the search sequence. In another embodiment, once the optimal translation is estimated, a series of rotations are applied as scored as above. The highest scoring displacement between the images is then set to the highest scoring translations followed by the highest scoring rotation.

In step 725, an image similarity score based on the measurement of the optimal difference or translation may be compared to an adaptive or predefined threshold. If this test fails, the match returns a “fail.” Otherwise, the process proceeds onto the generation of matching scores in steps 726, 727 and 728.

In an alternative embodiment, the rigid-body translation, (tₓ, t_{y}) is estimated using a hierarchical multi-resolution search as described previously, except that the translations are scored using the rate of matching VCSs within the DRR and the LRR and/or the distance between corresponding VCSs within the DRR and the LRR. VCSs are deemed to correspond if they are nearest-neighbors and the distance between them is less than a threshold. The highest scoring translation corresponds to the highest proportion of matching VCSs and/or the smallest measured average distance between VCSs. This score may be used as the final matching score and compared with a threshold. If this test fails, the match returns a “fail.” Otherwise, the process returns a “pass” match result. Alternatively, if the test is passed, the process proceeds onto the generation of matching scores in steps 726, 727 and 728. Note that this technique may be used to replace or complement step 722 described previously.

In one embodiment, the video frame in the LRR is encoded as a retina code for a second time, except that the ellipse used to define the polar coordinates is set to be the one within the SSR in the DRR translated by the calculations of step 724. This new retina code encoding is compared to the encoding within the DRR. A match score is generated by the proportion of VCRs in the two retina codes whose parameters match within predetermined ranges.

However, FIG. 7 shows an alternative way to generate matching scores. In particular, where a VCS is identified in the LRR retina code, a model fit method is applied to the video frame in the DRR in step 726. The matching score is the proportion of instances where a comparable VCS is found in the database image. Conversely, where there is a VCS identified in the DRR retina code, a model fit method is applied to the video frame in the LRR in step 727. A second matching score is calculated in this case. A combination of the two scores becomes the final matching score in step 728. It is now possible to compare this score against a threshold in step 729. If the threshold is exceeded, the matching process returns “pass” indicating a positive match; otherwise, a “fail” is returned.

Quickly and efficiently retrieving reference data for the matching process is critical to achieving high match rates. The speed at which reference data can be retrieved is dependent upon several factors, such as basic storage I/O speed, intelligent binning (data grouped according to demographic and feature-based classification), and intelligent caching. Demographic grouping can include age, sex, and eye color, but is not limited to these attributes. Feature-based grouping can include enrollment-dependent features such as total number of vessels, total vessel cross sections, vessel lengths, vessel widths, vessel heights, and vessel to vessel distances.

Feature-based information, retina codes, and the video frames they are derived from can be stored independently. For the embodiment which includes a matching process that necessarily terminates at step 722 video frames, template bitmaps and data required for steps 723 to 729 are not stored. For alternative embodiments that utilize step 722 as a pre-filter this data need only be retrieved from data storage when the matching process meets the tests at step 722.

The actual retrieval searching methods (dependent on database schema) can include, but are not limited to, simple comparison, hashing, neural network-based, genetic algorithm-based, and hidden Markov-based methods.

The binning comparisons, data retrieval, and matching can be performed by independent or dependent processes, running on the same or multiple physical processors. Indeed, each of the three operations can execute on N (N≧1) physical processors and/or machines, with data retrieved from M (M≧1) physical storage systems. In one embodiment all the processes run on a single physical processor and retrieve data from a single physical storage system, all part of a single physical machine, such as a computer laptop or workstation. In another embodiment each bin is allocated a single physical machine. In yet another embodiment, each bin is allocated a single physical machine for binning and matching, while an enterprise-wide data management and storage system is shared by all bins.

In one embodiment of a Cartesian-based retina encoding and matching system, the retrieved data for matching is on the order of two to four kilobytes per reference code, implying that for two hundred fifty thousand to five hundred thousand reference codes, one gigabyte of memory is necessary. For small enrollee populations the entire reference data set can be placed in high speed system memory (such as DDR) on a currently available laptop computer, or a mobile smart camera system with one to two gigabytes of system memory. Data discrimination, data retrieval, and data matching are completely scaleable in storage capability and matching speed.

In general, caching and other data storage by exemplary embodiments of the present invention may be achieved with networked or non-networked systems that employ physical storage media of various forms, including, but not limited to, hard disk, optical disk, magneto-optical disk, RAM, and the like.

Furthermore, physical processors and/or machines employed by exemplary embodiments may include one or more networked or non-networked general purpose computer systems, microprocessors, digital signal processors, micro-controllers, and the like, programmed according to the teachings of the exemplary embodiments of the present invention, as is appreciated by those skilled in the computer and software arts. Appropriate software can be readily prepared by programmers of ordinary skill based on the teachings of the exemplary embodiments, as is appreciated by those skilled in the software art. In addition, the devices and subsystems of the exemplary embodiments can be implemented by the preparation of application-specific integrated circuits or by interconnecting an appropriate network of conventional component circuits, as is appreciated by those skilled in the electrical art(s). Thus, the exemplary embodiments are not limited to any specific combination of hardware circuitry and/or software.

Stored on any one or on a combination of computer readable media, the exemplary embodiments of the present invention may include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present inventions can be distributed for better performance, reliability, cost, and the like.

Common forms of-computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present invention has been described in connection with a number of exemplary embodiments, and implementations, the present inventions are not so limited, but rather cover various modifications, and equivalent arrangements, which fall within the purview of prospective claims. For instance, although the embodiments of the present invention described herein employ various forms of spatial (two-dimensional) gradient, the present invention is not limited to these specific ways of determining spatial variation.

What we claim is:

1. A method for identifying retinal blood vessels for biometric identification, the method comprising:
receiving at least one image with retinal data;
detecting an area in the at least one image corresponding to a spatial variation in the at least one image; and
determining a blood vessel pattern in the area corresponding to the spatial variation in the at least one image.

2. The method according to claim 1, wherein the step of detecting an area in the at least one image corresponding to a spatial variation in the at least one image includes detecting an area corresponding to a spatial intensity gradient.

3. The method according to claim 1, further comprising defining the area corresponding to the spatial variation by a fitted shape.

4. The method according to claim 3, wherein, in the step of defining the area corresponding to the spatial variation by a fitted shape, the fitted shape is expressed in a polar coordinate system.

5. The method according to claim 3, wherein, in the step of defining the area corresponding to the spatial variation by a fitted shape, the fitted shape is expressed in a Cartesian coordinate system.

6. The method according to claim 3, further comprising comparing the fitted shape to a threshold to determine an image quality.

7. The method according to claim 1, further comprising:
determining a measure of focus and sharpness for the image; and
comparing the measure of focus and sharpness to a threshold to determine an image quality.

8. The method according to claim 1, wherein the step of determining a blood vessel pattern comprises:
determining blood vessel cross sections within the area corresponding to the spatial variation in the at least one image; and
linking the blood vessel cross sections to determine blood vessels.

9. The method according to claim 8, wherein the step of determining blood vessel cross sections within the area corresponding to the spatial variation in the at least one image includes representing each of the blood vessel cross sections by an N-vector determined from at least one of a N-parameter non-linear fitting function and a linear function combination.

10. The method according to claim 9, wherein the step of representing each of the blood vessel cross sections by an N-vector includes fitting a non-linear five-parameter model to intensity profiles within the area according to a Levenberg-Marquardt method.

11. The method according to claim 10, wherein, in the step of fitting a non-linear five-parameter model to intensity profiles within the area according to a Levenberg-Marquardt method, the intensity profiles are samples of a length along concentric ellipses at different radii.

12. The method according to claim 10, wherein, in the step of fitting a non-linear five-parameter model to intensity profiles within the area according to a Levenberg-Marquardt method, the intensity profiles are samples of a length along two perpendicular axes.

13. The method according to claim 8, further comprising determining bifurcations and locations of entry and exit for the blood vessels.

14. The method according to claim 1, wherein, in the step of receiving at least one image with retinal data, the at least one image is an image bitmap.

15. The method according to claim 1, wherein, in the step of receiving at least one image with retinal data, the at least one image is in a video frame of a camera with a field-of-view, and the step of detecting the area corresponding to the spatial variation comprises:
detecting an outer edge of the field-of-view of the camera; and
shrinking the outer edge non-uniformly until a spatial intensity gradient is detected.

16. The method according to claim 15, wherein the step of detecting an outer edge of the field-of-view of the camera comprises:
determining horizontal, vertical, and angular projections of gradient of the video frame; and
applying local edge detection.

17. The method according to claim 1, further comprising checking the blood vessel pattern for at least one of a minimum number of vessels, a minimum path length of detected blood vessels, and a minimum number of at least one of bifurcations and entry/exit points to determine a retina code quality.

18. The method according to claim 1, further comprising storing the blood vessel pattern to enroll the image for biometric identification.

19. The method according to claim 1, further comprising comparing the blood vessel pattern with a reference blood vessel pattern for biometric identification.

20. The method according to claim 19, further comprising, before comparing the blood vessel pattern with a reference blood vessel pattern, normalizing the blood vessel pattern and the reference blood vessel pattern.

21. The method according to claim 20, wherein the step of normalizing the blood vessel pattern and the reference blood vessel pattern includes encoding a region around each blood vessel in the blood vessel pattern as a template bitmap.

22. The method according to claim 20, wherein the step of normalizing the blood vessel pattern and the reference blood vessel pattern includes encoding a single region defined about a center.

23. The method according to claim 19, further comprising, before comparing the blood vessel pattern with a reference blood vessel pattern, correcting for displacement between the blood vessel pattern and the reference blood vessel pattern.

24. The method according to claim 23, wherein the step of correcting for displacement between the blood vessel pattern and the reference blood vessel pattern includes aligning blood vessels directly.

25. The method according to claim 24, wherein the step of aligning blood vessels directly includes determining vessel-by-vessel comparisons of distance.

26. The method according to claim 24, wherein the step of aligning blood vessels directly includes applying rigid-body transformations.

27. The method according to claim 19, wherein the step of comparing the blood vessel pattern with a reference blood vessel pattern comprises comparing encodings for the blood vessel pattern and the reference blood vessel pattern.

28. The method according to claim 19, wherein the step of comparing the blood vessel pattern with a reference blood vessel pattern comprises comparing vessel cross sections between the blood vessel pattern and the reference blood vessel pattern.

29. The method according to claim 1, further comprising the step of determining a structural measurement in the area corresponding to the spatial variation, wherein the step of determining a blood vessel pattern in the area comprises determining a blood vessel pattern in the area relative to the structural measurement.

30. The method according to claim 29, wherein the step of determining a structural measurement in the area corresponding to the spatial variation includes determining a structural center of mass in the area corresponding to the spatial variation.

31. The method according to claim 29, wherein the step of determining a blood vessel pattern comprises:
determining blood vessel cross sections within the area relative to the structural measurement; and
linking the blood vessel cross sections to determine blood vessels.

32. The method according to claim 29, further comprising comparing the structural measurement to a threshold to determine an image quality.

33. A system for identifying retinal blood vessels for biometric identification, the system comprising:
means for receiving at least one image with retinal data;
means for detecting an area in the at least one image corresponding to a spatial variation in the at least one image; and
means for determining a blood vessel pattern in the area corresponding to the spatial variation in the at least one image.

34. The system according to claim 33, wherein the means for detecting an area in the-at least one-image corresponding to a spatial variation in the at least one image includes means for detecting an area corresponding to a spatial intensity gradient.

35. The system according to claim 33, further comprising means for defining the area corresponding to the spatial variation by a fitted shape.

36. The system according to claim 35, wherein the fitted shape is expressed in a polar coordinate system.

37. The system according to claim 35, wherein the fitted shape is expressed in a Cartesian coordinate system.

38. The system according to claim 35, further comprising means for comparing the fitted shape to a threshold to determine an image quality.

39. The system according to claim 33, further comprising:
means for determining a measure of focus and sharpness for the image; and
means for comparing the measure of focus and sharpness to a threshold to determine an image quality.

40. The system according to claim 33, wherein the means for determining a blood vessel pattern comprises:
means for determining blood vessel cross sections within the area corresponding to the spatial variation in the at least one image; and
means for linking the blood vessel cross sections to determine blood vessels.

41. The system according to claim 40, wherein the means for determining blood vessel cross sections within the area corresponding to the spatial variation in the at least one image includes means for representing each of the blood vessel cross sections by an N-vector determined from at least one of a N-parameter non-linear fitting function and a linear function combination.

42. The system according to claim 41, wherein the means for representing each of the blood vessel cross sections by an N-vector includes means for fitting a non-linear five-parameter model to intensity profiles within the area according to a Levenberg-Marquardt system.

43. The system according to claim 42, wherein the intensity profiles are samples of a length along concentric ellipses at different radii.

44. The system according to claim 42, wherein the intensity profiles are samples of a length along two perpendicular axes.

45. The system according to claim 40, further comprising means for determining bifurcations and locations of entry/exit points for the blood vessels.

46. The system according to claim 33, wherein the at least one image is an image bitmap.

47. The system according to claim 33, wherein the at least one image is in a video frame of a camera with a field-of-view, and the means for detecting the area corresponding to the spatial variation comprises:
means for detecting an outer edge of the field-of-view of the camera; and
means for shrinking the outer edge non-uniformly until a spatial intensity gradient is detected.

48. The system according to claim 47, wherein the means for detecting an outer edge of the field-of-view of the camera comprises:
means for determining horizontal, vertical, and angular projections of gradient of the video frame; and
means for applying local edge detection.

49. The system according to claim 33, further comprising means for checking the blood vessel pattern for at least one of a minimum number of vessels, a minimum path length of detected blood vessels, and a minimum number of at least one of bifurcations and entry/exit points to determine a retina code quality.

50. The system according to claim 33, further comprising means for storing the blood vessel pattern to enroll the image for biometric identification.

51. The system according to claim 33, further comprising means for comparing the blood vessel pattern with a reference blood vessel pattern for biometric identification.

52. The system according to claim 51, further comprising means for normalizing the blood vessel pattern and the reference blood vessel pattern.

53. The system according to claim 52, wherein the means for normalizing the blood vessel pattern and the reference blood vessel pattern includes means for encoding a region around each blood vessel in the blood vessel pattern as a template bitmap.

54. The system according to claim 53, wherein the step of normalizing the blood vessel pattern and the reference blood vessel pattern includes encoding a single region defined about a center.

55. The system according to claim 53, further comprising means for correcting for displacement between the blood vessel pattern and the reference blood vessel pattern.

56. The system according to claim 55, wherein the means for correcting for displacement between the blood vessel pattern and the reference blood vessel pattern includes means for aligning blood vessels directly.

57. The system according to claim 56, wherein the means for aligning blood vessels directly includes means for determining vessel-by-vessel comparisons of distance.

58. The system according to claim 56, wherein the means for aligning blood vessels directly includes means for applying rigid-body transformations.

59. The system according to claim 51, wherein the means for comparing the blood vessel pattern with a reference blood vessel pattern comprises means for comparing encodings for the blood vessel pattern and the reference blood vessel pattern.

60. The system according to claim 51, wherein the means for comparing the blood vessel pattern with a reference blood vessel pattern comprises means for comparing vessel cross sections between the blood vessel pattern and the reference blood vessel pattern.

61. The system according to claim 33, further comprising the means for determining a structural measurement in the area corresponding to the spatial variation, wherein the means for determining a blood vessel pattern in the area comprises means for determining a blood vessel pattern in the area relative to the structural measurement.

62. The system according to claim 61, wherein the means for determining a structural measurement in the area corresponding to the spatial variation includes means for determining a structural center of mass in the area corresponding to the spatial variation.

63. The system according to claim 61, wherein the means for determining a blood vessel pattern comprises:
means for determining blood vessel cross sections within the area relative to the structural measurement; and
means for linking the blood vessel cross sections to determine blood vessels.

64. The system according to claim 61, further comprising means for comparing the structural measurement to a threshold to determine an image quality.
